(19) United States
(12) Patent Application Publication
(10) Pub. No.: US 2002/0017999 A1
(43) Pub. Date: Feb. 14, 2002

(54) Searching system

(76) Inventor: Yasumasa Akazawa, Osaka (JP)

Correspondence Address: MOONRAY KOJIMA, Box 627, Williamstown, MA, 01267, US

(21) Appl. No.: 09/792,821

(22) Filed: Feb. 23, 2001

(30) Foreign Application Priority Data
Aug. 10, 2000 (JP) 2000/242,650

(51) Int. Cl. G08B 19/02

(52) U.S. Cl. 340/581

(57) ABSTRACT

The present invention relates to the effective searching system for searching the criminals fleeing at large or straying persons, wherein the utilizing media provided with the information to specify the individual is used to send the personal information concerning the above said utilizing media and the terminal information concerning the terminal using the said utilizing media to the searching center from the utilizing system side of the utilizing media through the sending means so that the controlling means at the above said searching center records the personal information which has been sent, and the utilized information of the utilizing media corresponding to the individual on the basis of the terminal information onto the recording measures for management, thus providing for the search for the place of the utilizing media which has been used and identifying the final place of use of the utilizing media as a wanted spot when searching for the person who has used the said utilizing media, where the area of activities for searching will be pinpointed.

### BACKGROUND OF THE INVENTION

1. Field of the Invention

The present invention relates to an effective searching system for searching the criminals at large or looking for people who got lost, for instance.

2. Description of the Prior Art

As a conventional means for searching people, there was a searching (research) consisting in getting information by visiting each person who is likely to have some tips on the culprit or collecting information by making public the objects (arrangement of the searching system) and there has not been any better system related nor has there been any better helping system to help public search or interviewing persons involved.

### SUMMARY OF THE INVENTION

The main purpose of the present invention is to provide a searching system made effective when using an utilizing media provided with information to specify the individual in question, wherein the individual information concerning the said utilizing media and the terminal information concerning the terminal using the said utilizing media are transmitted to the searching center from the utilizing system side of the utilizing media, the control means of the said searching center recording the information to use in the utilizing media corresponding to the individual on the basis of the terminal information or individual information which are transmitted for management, thus allowing for searching for a place of the utilization media which has been used, wherein the final place for using the utilization media will be specified as a spot for research, thus pinpointing the research activity area.

Another purpose of the present invention is to provide a searching system capable of carrying out effectively the searches for the criminals, wherein the history of the information which has been used is recorded on the recording media of the searching center and the history of the information used of the utilizing media enables grasping the whereabouts of the criminals, thus allowing for pinpointing the place that can be reached in a short time using the final information.

Another purpose of the present invention is to provide a searching system capable of listing passengers or criminals trying to board a plane or not, before and after the take-off when illegal entry into the country under the immigration control is to be found at an airport or at a port, wherein the searching center is provided with the reference device for outputting the results of comparative references based on the individual information of the searching objects and the individual information in control, thus allowing for outputting the results of the comparative references of the individual information of the searching center to the terminals.

Furthermore, another object of the present invention is to provide a searching system capable of effectuating the response on the side of the terminals, wherein the utilizing media is designed to be one or a plurality of the media like credit cards, social security cards, IC cards containing a transmitter, passports, ID cards, driver's licenses, health insurance certificate, mobile phones, all other media provided with a function to specify the individuals, enabling the assumption of the stolen goods or lost properties in case these utilizing media are used away from where the utilizing media should be used, making it possible to confirm the lost and stolen utilizing media and eventually to stop the use of them.

Other objects of the present invention will be clarified according to the examples of the preferred embodiment as below.

### BRIEF DESCRIPTION OF THE DRAWING

FIG. 1 is a constructive block view of the searching system

FIG. 2 is a perspective view of the terminal

FIG. 3 is a flowchart showing the collection of the terminal information or individual information

FIG. 4 is an explanatory view showing the recording example of the history of use of the utilizing media

FIG. 5 is a flowchart of searching the clients

FIG. 6 is a flowchart of looking for the clients

FIG. 7 is a constructive block view of the searching system of other examples

FIG. 8 is a flowchart explaining the collection of the control information FIG. 9 is a constructive block view showing other examples of the searching system

FIG. 10 is a flowchart explaining the collection of the control information control information

### DESCRIPTION OF THE PREFERRED EMBODIMENT

One example of the present invention will be explained with the below drawings.

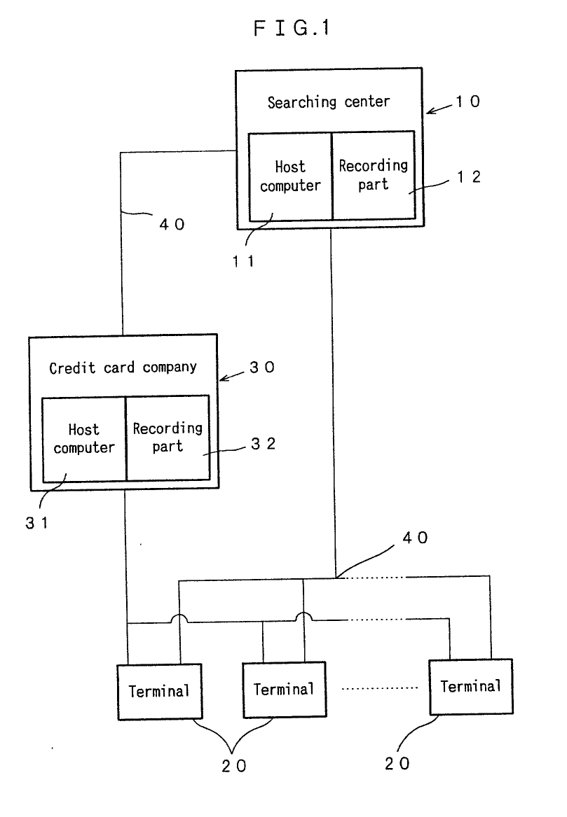

One drawing shows the searching system and according to the FIG. 1, the searching system comprises the searching center 10 and the terminal 20, wherein in this example the credit card company 30 is taken for example.

The searching center 10, the terminal 20 and the credit card company 30 are connected by the network 40 which is a communication device. This network 40 may be wireless or comprise wire or may be provided with a complex of communicating devices including the communication satellite.

The searching center 10 carries out the searching process, reference process, communicating process and all other control processes by a host computer 11, thus recording all the information necessary for recording memory like the individual information or terminal information.

The credit card company 30 will allow for the contracted client to carry out the trading by a credit card, effectuating the trading process by a credit card using a host computer 31 and memory-recording various data of the trading on the recording part 32. Naturally, the host computer 31 is provided with a function of carrying out the communicating process and other control process.

The recording part 32 has the individual information of each client who has made a contract, recorded for memory and this personal information is about the address, name, sex, age, phone number, credit number, photographed face (physical information), all of them capable of specifying the client (or a person) by a combination of them or independently. In addition, when the voiceprint or fingerprint is needed by the client as a physical information, the information involving voiceprint and fingerprint may as well be collected and recorded in respect of the characteristic volume.

The terminal 20 and others so on will be distributed in a wide range of the areas so that they are distributed against the shops which have contracted with the credit card company 30. Furthermore, the said terminal 20 has the individual information and trading information of the client inputted in time of the trading by a credit card.

The information available on the credit card as the personal information of the client may be, for example, the name of the credit card company, credit number, a person's name, photographed face (or a characteristic volume of the face), wherein the clerk inputs and manipulates the personal information.

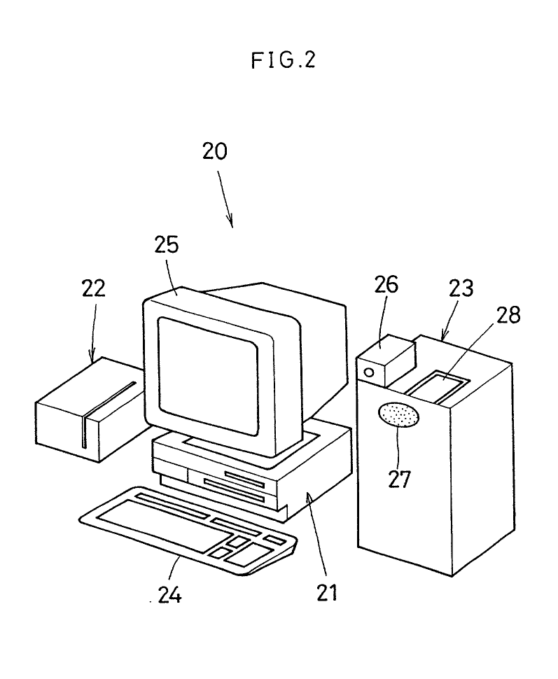

The FIG. 2 shows the terminal 20, which terminal 20 comprises the personal computer 21, card-readable device 22 and physical information collecting device 23, wherein the personal computer 21 is connected with the key board 24 as an inputting measure and the display 25 as an outputting measure. It is needless to say that to connect a printer is also feasible. The personal computer 21 is provided with a communicating function and also connected to the network 40 while the card-readable device 22 is connected to the network 40 through the control of the personal computer 21. Also by inserting the credit card possessed by the client therein, the card-readable device 22 can read the data of each card and the card data which has been read will be inputted into the personal computer 21 and thus processed.

The personal computer 21 is connected with the collecting device of the physical information, which collecting device of the physical information 23 is provided with the CCD camera 26 for taking picture of the client's face, the microphone 27 for collecting the voiceprint from the voice of the conversations and the reading device of the fingerprint 28 which collects the fingerprint of the finger ready for the inspection, wherein the collecting device of the physical information 23 is set toward the client in its front.

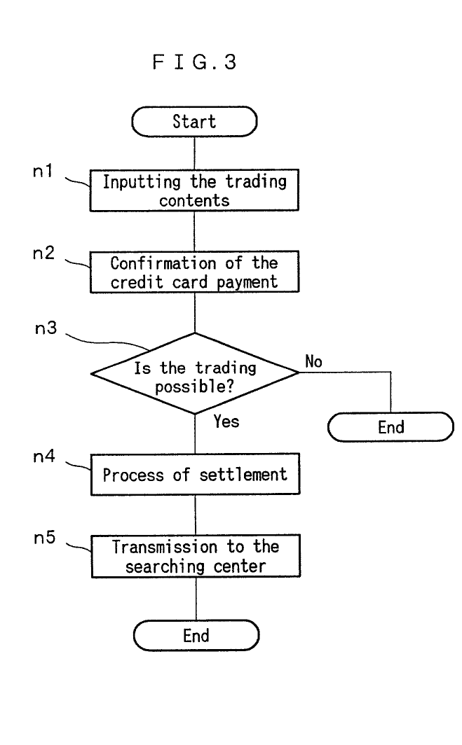

The FIG. 3 shows the process of the terminal 20 for transmitting the individual information and the terminal information of the client to the searching center 10 together with a trading process involving the use of the credit card by the client.

In the time of commercial trading at a shop, the said trading content will be inputted with the personal computer 21 (step n1), and to follow, the credit card possessed by the client will be inserted into the card-readable device 22 which reads the card data, transmitting the card data and trading data to the credit card company 30 in order to confirm if the trading is possible or not (step n2).

In addition, when an identification media is needed to identify the individual other than a credit card in commercial trading, the clerk inputs the data contained in ID card, social security cards, passports, identification documents, driver's licenses, health care insurance documents, phone number an other media with a function to specify the individual after the clerks asking the clients to present them.

When the answer by telecommunication from the credit card company 30 shows the trading is impossible, the trading by a credit card will be put to an end, however, when the answer shows the trading is possible, the settlement by the credit card will be carried out (steps n3 and n4) and consequently the individual information of the client and terminal information of the terminal 20 will be transmitted to the searching center 10 (step n5).

The individual information is based on the card data recorded on the credit card, for example, when the ID card is used with the name of the credit card company, the credit number, the address, the name, the phone number, a photographed face (or the characteristic volume of the face), and other personal information inputted in regard to the client by the clerk, that is when ID card (personal identification card besides the credit card), or other utilizing media like social securities card are used, that ID card or other utilizing media like social security cards include the card data to be utilized and when the utilizing media is used to specify the above said individual, the individual information is based on the said utilizing media.

The terminal information includes the date of trading with the client, its time, the used type of a machine, the number of the terminal device, and the searching center 10 is provided with the recording part 12 including the used type of a machine, the number of the terminal machine in function with the file indicating the place of the said terminal so that the place of the terminal 20 can be specified.

In this way, when the client uses both the credit card and ID card (social securities cards and other utilizing measures) to do the commercial trade, the personal information of the said client and the terminal information of the terminal 20 which carried out the commercial trade will be sent to the searching center 10, which searching center 10 will record the history of use of the credit cad or ID card (or social security cards) by the client on the recording part 12. Furthermore, when the searching center 10 requires as much personal information as possible, it is possible to demand the presentation of the personal information by the credit card company 30, based on the information sent from the terminal 20.

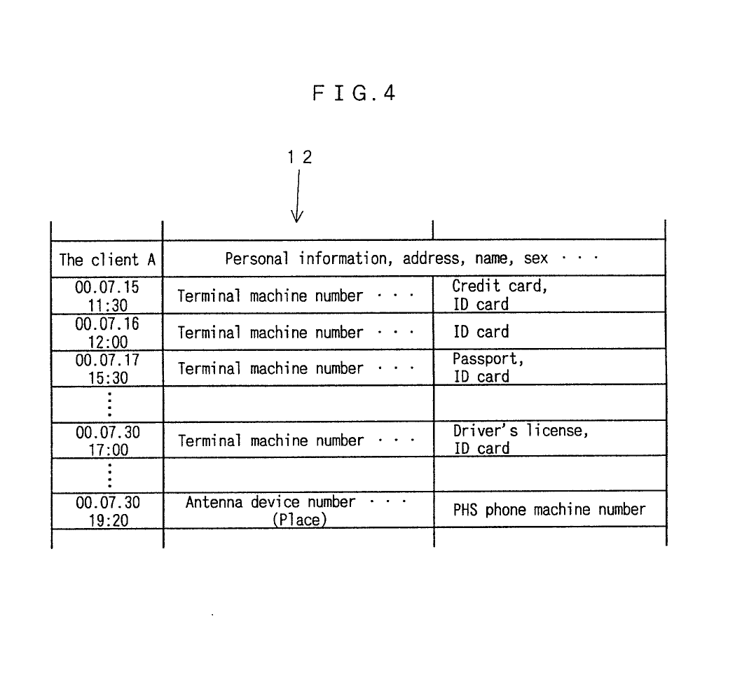

The FIG. 4 shows a recorded example of the history of use of other utilizing media like credit cards or ID cards (or social security cards and other utilizing media) concerning one client A, wherein the individual information of the client A includes the address, the person's name, sex, age, the phone number, the physical information like a photographed face (characteristic volume of the face), voiceprints, fingerprints), ID number, bank account number, credit card number and other information capable of identifying the individual by one or combination of several pieces of information and all information above will be collected from each of the card data by utilizing various cards. Among the terminal information are the data, time, the used type of machine, the number of terminal device on which the terminal 20 carries out the terminal process, all of which are recorded in relation with the utilizing media which has been used when carrying out the terminal process.

Therefore, with the use of various utilizing media, knowing the time of its use, the place of use, it is possible to search for the transference of the client A or transference of the utilizing media itself.

In searching for the transference of the utilizing media itself, when the area of use of the credit card is very far from the moving track of the client in respect of time and distance, the credit card will be assumed to be used by another person but the client so that, in this case, further trading will be warned against use while keeping the above said credit card regarded as lost or stolen.

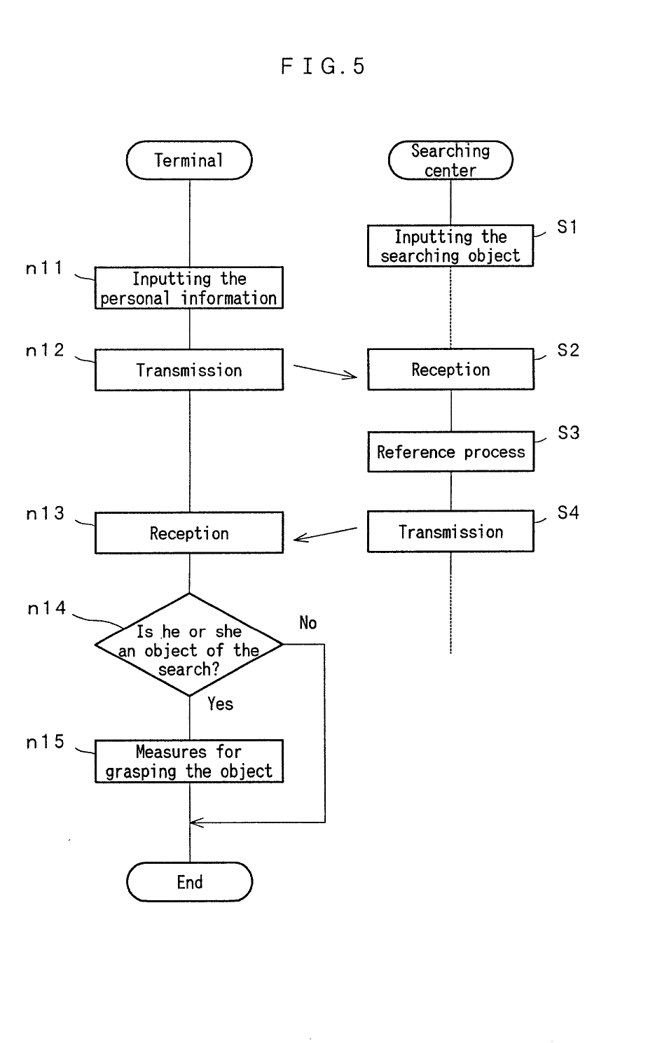

The FIG. 5 shows the transaction process of the searching center 10 and the terminal 20 in case of searching for the client and when searching for the client, personal information of the client who has been searched will be inputted into the searching center 10 so that the searching object will specified (step s1).

As is explained in the step n5 of the FIG. 3, the cards presented by the client, or personal information of the client or terminal information based on the physical information from the collecting device of the physical information 23 are transmitted from the terminal 20 (steps n11 and n12), when the above information is received by the searching center 10 (step s2), which information is referred to the information of the client who is the object of the search, recorded on the recording part 12, the reference results of deciding whether or not the searching object is the client to look for, will be sent to the terminal 20 (step s3, s4).

When the terminal 20 receives the reference results, which are beyond searching objects, the trading with the client will be put to an end, otherwise, the client will preserved by some means (step n13, n14, n15).

In this searching example, it will be effective in gates of the customs or the airport and when the criminal is specified on the utilizing media, it will be effective in searching the criminal.

According to another example of the search, information of the searching object, for instance, a photographed face will be sent from the searching center 10 the terminal 20 or by putting the information of control on the screen of the television in the town, which information is to be obtained from the terminal 20, the search can be done. In this case also, it is possible to look for a criminal in an effective manner.

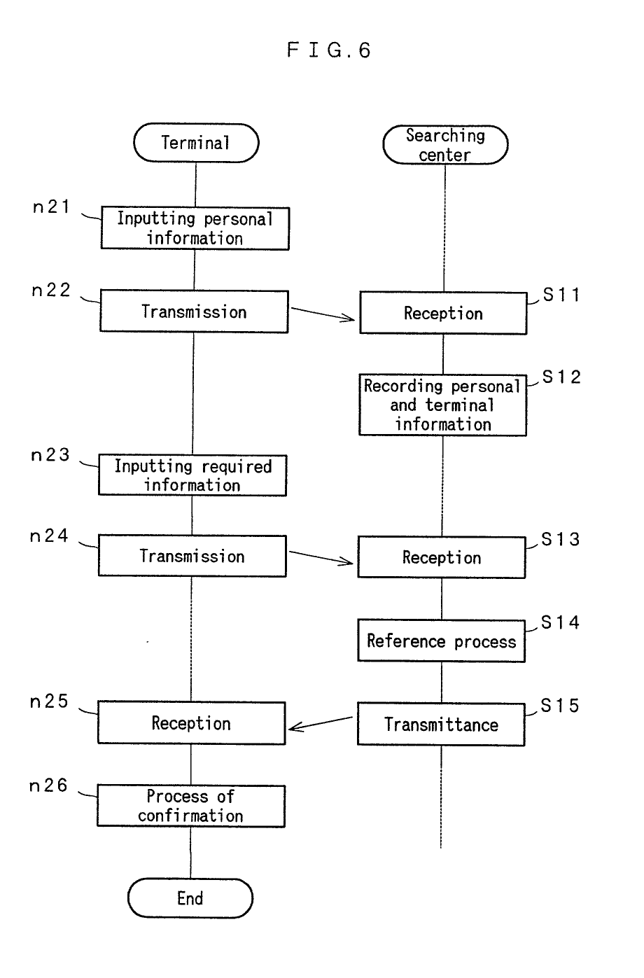

In the FIG. 6, there is shown an operation process of the searching center 10 and terminal 20 in case of asking for the client to the searching center.

As explained in the step n5 of the FIG. 3, when cards submitted by the client (utilizing media) or personal information and terminal information of the client on the basis of the physical information from the collecting device of the physical information 23 are submitted from the terminal 20 (steps n21, n22), the searching center 10 will record the personal information and terminal information of the client on the recording part 12 (steps s11, s12).

When the terminal 20 has processed the list of the clients in a determined period of time, that terminal 20 provides and sends the asked information and terminal information when required (steps n23, 24).

When the searching center 10 receives the inquired information, the terminal 20 makes a list of the clients who have been processed in a certain period of time and the searching center 10 transmits this on the basis of the terminal information of the said terminal 20 (Steps s13, s14, s15).

When the terminal receives the list of the clients, this will be outputted to the terminal display 25, wherein the presence of the clients will be confirmed and processed according to the said list (Steps n25 and n26).

In this example of inquiry, for instance when the airplane has encountered some accident in the airport, the above steps are effective in confirming the passengers on board of that plane.

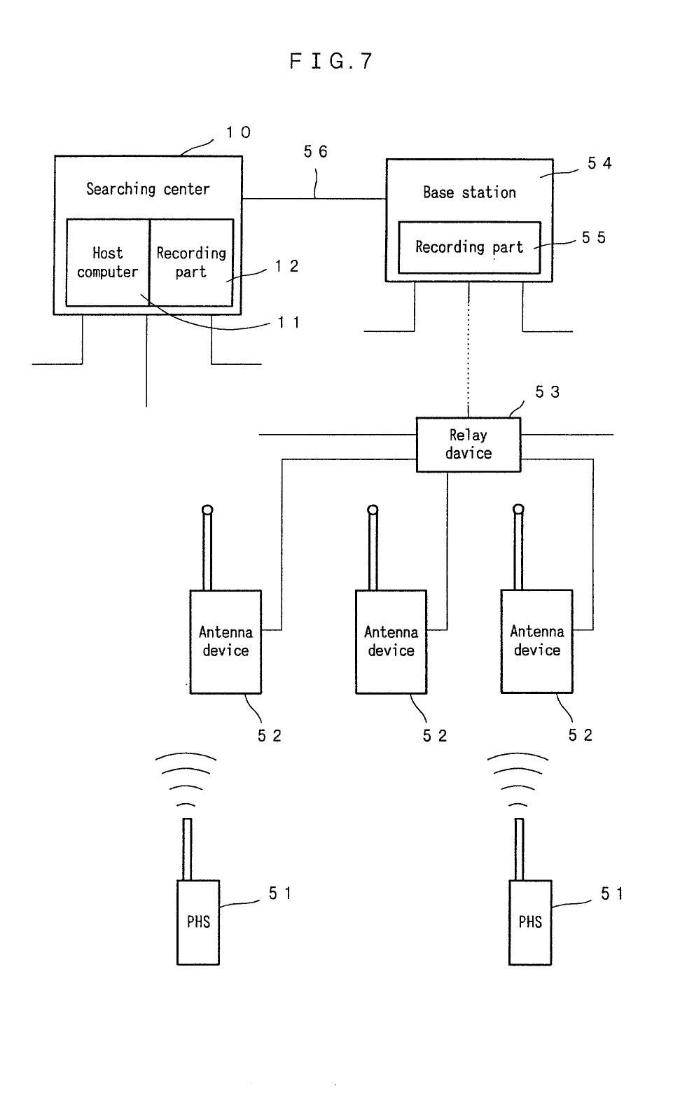

The FIG. 7 shows the searching system, which consists in collecting used information of the mobile phone machines. As for mobile phone machines, there are PHS phone machines, mobile phone machines, automobile phone machines and according to the above mentioned example, the PHS telephone machine will be explained about.

PHS phone machine 51 will be connected with the antenna devices 52 and so on, many of which will be distributed over places, each from another at a determined distance and each antenna device 52 will be connected to the base station 54 through one or more than one of the relay devices 53, wherein the said base station 54 will record watching information sent and history of the talks by the PHS phone machine 51 on the recording part 55, thus watching the move of the said PHS phone machine 51.

The base station 54 and the searching center 10 are connected with each other on the communicating line 56 (wire or wireless, or both combined), and the searching center 10 has recorded personal information by utilization of other utilizing media and history of use of utilizing media based on the terminal information as explained in the FIGS. 1 to 4 so that the watching information of the above said PHS phone machine 51 will be added to the said record and recorded.

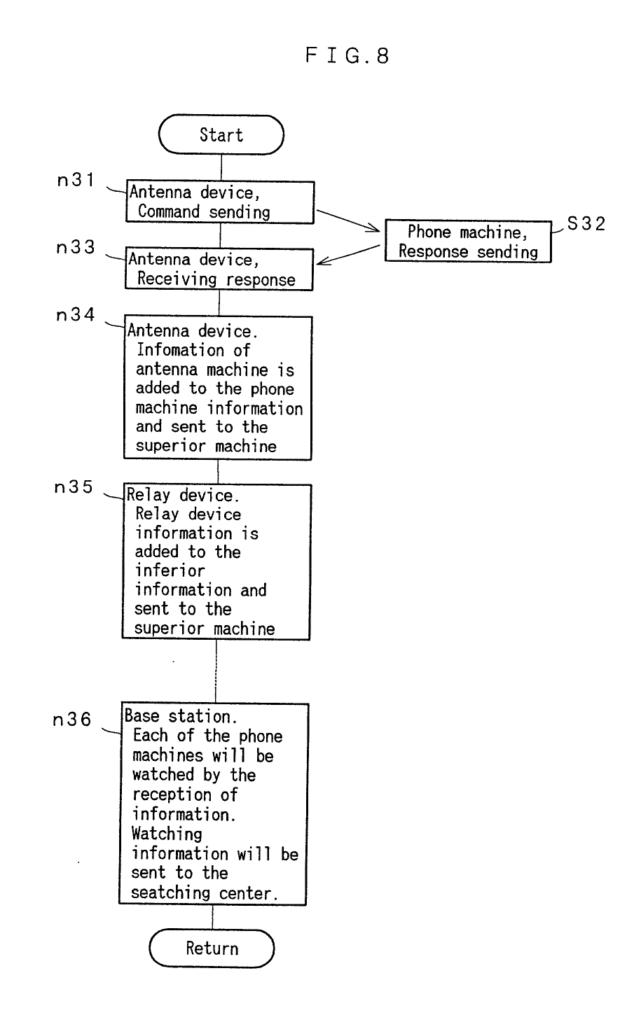

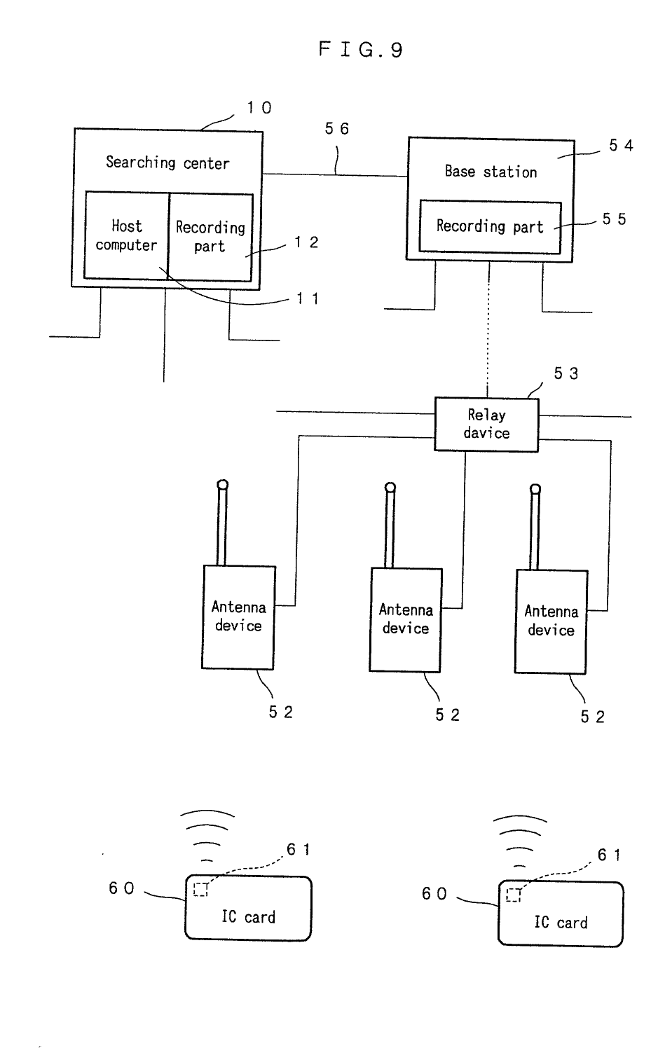

According to the FIG. 8, the collection of the watching information concerning one PHS phone machine 51 will be explained below.

When PHS pone machine 51 is electrically connected, that phone machine is designed to emit some response with respect to the command from the antenna device 52 and when the command is emitted from each of antenna devices 52 with a determined pause of time, PHS phone machine 51 will emit some phone machine information as a response, for example, the phone number information as one which distinguishes its source (steps n31 and n32).

When the antenna device 52 receives the response, the antenna device information of the said antenna device 52, for example, the number for distinguishing the antenna device will be added to the phone machine information and sent to the superior machine (step n33, n34).

In addition, the number for distinguishing the antenna device is preserved at the base station 54 in reference to the place of its installment and this number for distinguishing the antenna device is useful in finding out the place of the PHS phone machine 51 when the response is emitted.

When the relay device 53 receives the information sent from the inferior machine, the relay device information, for instance, the number for distinguishing the relay device will be added to this inferior information and sent to the superior machine (step n35).

With the information of the relay device concerning the number for distinguishing the above said relay device, the base station 54 is able to grasp the communicating route of the inferior information, while the number for distinguishing the relay device will help find out the place of the said relay device because the number is preserved at the base station in correspondence with the place of its installment.

In this way, when the base station 54 receives the inferior information sent through one or more than one of the relay devices 53, this inferior information, namely the phone machine number, the number for distinguishing the antenna device and the number for distinguishing the relay device will control the PHS phone machine 51. Under this control, when the said PHS phone number 51 dials and carries out emission, it will be connected with the place to be dialed and when the above said PHS phone machine 51 is dialed as a target from outside, this outer communication will be connected.

On the other hand, the base station 54 preserves personal information of the owner of the phone according to the phone machine number in respect of the searching center 10 so that the phone machine number, personal information of the owner of the phone, and the antenna machine number (information about the place) in time of control will be transmitted (step n36).

In this way, the base station 54 watches the move of each PHS phone machine 51 and sends information obtained from that watch to the searching center 10.

On the other hand, the searching center 10 records the information that has been used and the history of PHS phone machine 51 as already explained in the FIG. 4.

As in the above example where PHS phone machine 51 is explained about, the mobile phone machine, automobile phone machines can also watch the move of the owner and record the history of use.

As said above, the history of use of the mobile phone machine will be recorded together with the history of use of other utilizing media so that the whereabouts of the client A can be searched according to the time and place of use of the said machine and media, thus providing for searching the whereabouts of the moving phone machine itself.

In respect of the search for the move of the moving phone machines (for example, the above said PHS phone machine 51) themselves, if comparing with the moving tracks of the client, the region of use of the moving phone machine is far away from the said tracks of the client in respect of time and distance, the moving phone machine will be assumed to be used by another person than the owner, thus holding the said moving phone machine lost or stolen, providing for service of confirmation by reporting to the client before the said client presents a declaration of lost objects or robbery.

Furthermore, when the criminal possesses the moving phone machine and uses it while fleeing, and the phone number of this moving phone machine is specified, the criminal will be pinpointed in a place to be searched by getting the watching information of the moving phone machine which he or she carries.

In other words, when the phone machine number is watched among watching information sent from the base station 54 and the number corresponding to the moving phone machine carried by the criminal is detected, the place of installment of the said antenna device 52 will be found out according to the antenna device number of the watching information, thus pinpointing the place of a criminal and getting effective seizure of the criminal.

In addition, for another example, when the phone machine number of the moving phone machine carried by the criminal wanted is referred to at the base station 54, which base station 54 detects the corresponding the moving phone machine by watching the move of the said moving phone machine, the whereabouts of the criminal will be pinpointed after the searching center 10 grasps the location of the above said antenna device 52.

The FIG. 9 shows the searching system for collecting the information to be utilized of the IC card (card with an integrated circuit).

IC card 60 generates the starting electricity by electromagnetic waves from outside, which electricity works, containing the oscillator 61, which oscillates super-micro electric wave constantly, wherein this IC card 60 is to be used for various types of trades and the antenna devices 52 which communicates with this IC card 60 will be used also as an antenna device of the PHS phone machine so that many of these antenna devices will be distributed over each place at a each distance from one another, providing for each antenna device 52 to be connected to the base station 54 through one or more than one of the relay devices 53, which base station 54 will record the watching information and the history of communication of the IC card 60, which has been sent, onto the recording part 55, thus watching the move of the above said IC card 60.

The base station 54 and the searching center 10 are connected with each other by a communicating line 56 (wire or wireless, or combining both), wherein the searching center 10 is recording the personal information gained through the use of other utilizing media and the history of use of the utilizing media on the basis of the terminal information as explained in the FIGS. 1 to 4, thus recording the watching information of the IC card 60, adding thereto.

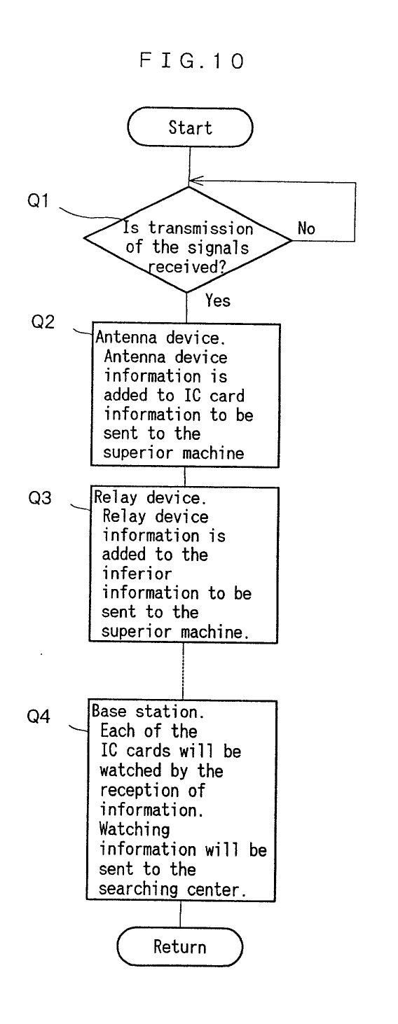

According to the FIG. 10, the collection of the watching information concerning one IC card 60 will be more particularly explained below.

The IC card 60 has the oscillator 61 contained, constantly oscillating the weak electric wave as an IC card information and when the antenna device 52 receives the above said oscillating signals, these will be added to the information of the above said antenna device 52, for instance, the card information having received the number for distinguishing the antenna device and sent to the superior machine (steps Q1, Q2).

Furthermore, the number for distinguishing the antenna device is kept at the base station 54 in correspondence with the place of its installation, thus allowing for finding out the place of the IC card 60 while adding the number for distinguishing the antenna device to the IC card information.

When the relay device 53 receives the information sent from the inferior machine, the relay device information, for example, the number for distinguishing the relay device is added to the said inferior information and sent to the superior machine (step Q3).

In addition, by the relay device information of the number for distinguishing the relay device, the communicating route of the inferior information can be grasped at the base station 54, and in the meantime, the number for distinguishing the relay device is kept at the base station 54 in correspondence with the place of its installation, thus allowing for finding out the said place according to the above said distinguishing number.

In this way, the inferior information sent through one or more than one of the relay devices 53 is received at the base station 54, this inferior information, namely IC card information, the number for distinguishing the antenna device and the number for distinguishing the relay device will help watch the IC card 60.

On the other hand, as the base station 54 keeps the personal information of the owner of the IC card in correspondence with its information, it will send the IC card information, the personal information of the owner of the IC card and the antenna device number (information concerning the place of its installation) on the spot where the watching is done, to the searching center 10 (step Q4).

In this way, the base station 54 watches the move of each of the IC cards 60 and sends the information obtained from watching to the searching center 10, thus allowing for searching the place of the IC card 60 even when the trading is not being done through the terminal 20 shown in the FIG. 2. On the other hand, when the IC card 60 is used with the credit card as well as the terminal 20, the place of the IC card can be searched, using the circuit device as in the FIGS. 1 to 5.

To summarize the above, the place of the utilizing media which has been used, can be searched so that the final place of use of the above said utilizing media can be specified as a searching point, when searching the person who has used the utilizing media, thus allowing for pinpointing the area of the searching activities and getting effective and effectuated.

In relation with the construction of the present invention and the examples of the preferred embodiments, the utilizing media of the present invention corresponds to the credit cards as in the examples, the IC card 60, social security cards, the passports, identification documents, the driver's license, health care documents, moving phone machines or other media capable of identifying the individuals, wherein the sending media corresponds to the host computer 11 of the searching center 10, a transmitting function of the personal computer 21 of the terminal 20 and the network 40, the communicating line 56, a transmitting function of the PHS phone machine 51 and the oscillator 61, the controlling media of the searching center corresponding to the controlling function of the host computer 11, the recording means corresponding to the recording part 12, outputting means corresponding to the display 25 of the terminal 20 with the reference means corresponding to the reference means of the host computer 11, however, the scope of the present invention will not be limited to the construction of the examples but allows for many examples of the preferred embodiment on the basis of the invention.

1. the searching system, wherein the personal information concerning the utilizing media and the terminal information concerning the terminal having used the said utilizing media are sent from the utilizing system of the utilizing media to the searching center through the sending measures when using the utilizing media provided with the information specifying the individual, the controlling measures of the above mentioned searching center recording the used information of the utilizing media corresponding to the individual on the basis of the terminal information and the personal information which has been sent, onto the recording means for management.

2. The searching system according to the claim 1, wherein the history of the used information is recorded onto the recording measures of the above said searching center.

3. The searching system according to the claim 1, wherein the personal information of the searching object and the personal information controlled are compared and referred to the searching center to output the results by the reference measure which is provided thereon.

4. The searching system according to the claim 1, wherein the utilizing media may as well be one or more than one of the media provided with a function to specify the individual like credit cards, social security cards, IC cards containing the oscillator, passports, ID cards, the driver's license, health care insurance documents, moving phone machines.
